(19) United States
(12) Patent Application Publication
(10) Pub. No.: US 2010/0110542 A1
(43) Pub. Date: May 6, 2010

(54) Polarizing lens

(75) Inventors: Hideyuki Sasaki, Morioka-shi (JP); Yoshiyuki Sakuraba, Hachimantai-shi (JP); Masaki Ito, Hachimantai-shi (JP); Takayuki Fujita, Hachimantai-shi (JP)

Correspondence Address: KANESAKA BERNER AND PARTNERS LLP, 1700 DIAGONAL RD, SUITE 310, ALEXANDRIA, VA, 22314-2848, US

(73) Assignee: Newton Co., Ltd., Hachimantai-shi (JP)

(21) Appl. No.: 12/379,327

(22) Filed: Feb. 19, 2009

(30) Foreign Application Priority Data
Nov. 6, 2008 (JP) 2008-285542

(51) Int. Cl. G02B 1/08

(52) U.S. Cl. 359/488; 428/413

(57) ABSTRACT

In a polarizing lens L which is obtained by a process in which a polarizing plate H formed by bonding protective films 2 and 3 to the both sides of a polarizing thin film 1 of polyvinyl alcohol, a thermoplastic resin film 10 is bonded to one side of the polarizing plate H with an adhesive or a sticking agent, the thermoplastic resin film 10 is subjected to curved molding such that this thermoplastic resin film 10 is positioned on the concave surface side, and a thermoplastic resin molded layer 11 formed of the same resin as that for the thermoplastic resin film 10 is laminated on the concave surface of this polarizing plate H, the protective films 2 and 3 are bonded to both sides of the polarizing thin film 1 with an adhesive, and a mixture of an epoxy resin and an acid anhydride is used as the adhesive.

### TECHNICAL FIELD

The invention relates to a polarizing lens used in glare-proof sunglasses, goggles, or the like.

### BACKGROUND ART

In respect to the above-mentioned polarizing lens, for example, a polarizing lens has conventionally been known which is obtained by subjecting to curved molding a polarizing plate formed by bonding protective films formed of acetyl cellulose both sides of a polarizing thin film made of polyvinyl alcohol, and laminating a polycarbonate resin layer on the concave surface of the polarizing plate. Regarding this polarizing lens, for example, the polarizing plate has a structure in which protective films are bonded to the both sides of a polarizing thin film with adhesive (see JP-A-2002-90529, for example).

Patent Document 1: JP-A-2002-90529

The above-mentioned conventional polarizing lens has the disadvantage that waterproofness is not necessarily good. Specifically, if immersed in water, the polarizing thin film and the protective film may peel off. The reason therefor is that, due to the hydrophilicity thereof, the polyvinyl alcohol constituting the polarizing thin film is easily affected by water and eluted.

The invention has been made in view of the above-mentioned problem, and the object thereof is to provide a polarizing lens with improved waterproofness by preventing the polyvinyl alcohol constituting the polarizing thin film from being eluted by water, thereby enabling the polarizing thin film to be bonded to the protective film without fail.

### DISCLOSURE OF THE INVENTION

In order to attain the object, the polarizing lens of the invention is a polarizing lens obtained by laminating a resin layer formed of a thermoplastic resin on a polarizing plate obtained by bonding protective films formed of acetyl cellulose to both sides of a polarizing thin film formed of polyvinyl alcohol, wherein the protective films are adhered to both sides of the polarizing thin film with an adhesive, and a mixture of an epoxy resin and an acid anhydride is used as the adhesive.

Examples of the thermoplastic resin constituting the resin layer include polycarbonate-based resins, polystyrene-based resin, acrylic-based resins containing a monopolymer or a copolymer of, e.g. methyl methacrylate or cyclohexyl methacrylate, vinyl chloride-based resins, polystyrene/methylmethacrylate-based resins, acrylonitrile/styrene-based resins, poly-4-methylpentene-1, main chain hydrocarbon-based resins having an andamantan ring or a cyclopentane ring as the main chain, polyester-based resins having a fluorene group as the side chain, polyamide-based resins such as transparent nylon, polyurethane-based resins, and cellulose-based resins, e.g. acylcellulose-based resins such as acetyl cellulose and propyl cellulose.

The thermoplastic resin layers may be appropriately provided. For example, one kind of the resin may be formed in a single layer, the same kinds of thermoplastic resins may be formed in a plurality of layers, or different kinds of the resins may be formed in a plurality of layers.

Since a mixture of an epoxy resin and an acid anhydride is used as an adhesive, bonding of polyvinyl alcohol constituting the polarizing thin film and the protective film can be ensured. In particular, elusion caused by water of polyvinyl alcohol constituting the polarizing thin film can be prevented, whereby waterproofness is improved. The reason therefor is considered to be as follows. The acid anhydride causes the epoxy resin to be hardened and forms a chemical bonding with the hydroxyl group of the polyvinyl alcohol, and undergoes three-dimensional hardening.

According to need, the above-mentioned epoxy resin is an epoxy resin having two or more epoxy groups within a molecule, wherein, as the epoxy resin, glycidylether-type epoxy resins, glycidylester- and glycidylamine-type epoxy resins, linear aliphatic epoxides, cyclic aliphatic epoxy resins are used singly or in a combination of two or more.

In this case, as the above-mentioned epoxy resin, it is effective to use, either singly or in combination of two or more, bisphenol A diglycidyl ether, bisphenol F diglycidyl ether, bisphenol S diglycidyl ether, resol phenol diglycidyl ether, brominated bisphenol A diglycidyl ether, fluorinated bisphenol A diglycidyl ether, phenol novolac glycidyl ether, cresol novolac glycidyl ether, brominated novolac glycidyl ether, polyglycol diglycidyl ether, hexahydrophthalic diglycidyl ester, phthalic diglycidyl ester, dimer acid diglycidyl ester, diglycidylanniline, diglycidyltoluidine, triglycidyl-p-aminophenol, triglycidyl-p-aminocresol, triglycidyl-m-aminophenol, triglycidyl isocyanulate, tetraglycidyl diaminodiphenylmethane, tetraglycidyl methaxylene diamine, tetraglycidyl diaminodiphenyl sulfoxide, epoxylated polybutadiene, epoxylated soy bean oil, 3,4-epoxy-6-methylcyclohexylmethyl carboxylate, 3,4-epoxycyclohexylmethyl carboxylate, 3,4-epoxycyclohexylmethyl-3′,4′-epoxycylohexane carboxylate, bis(3,4-epoxycylohexylmethyl)adipate and 1-epoxyethyl-3,4-epoxycylohexane.

Furthermore, according to need, as the above-mentioned acid anhydrides, maleic anhydride, dodecenyl succinic anhydride, sebacic anhydride, phthalic anhydride, pyromellitic anhydride, trimellitic anhydride, cyclopentane tetracarboxylic dianhydride, hexahydrophthalic anhydride, methylhexahyrophthalic anhydride, tetramethylene maleic anhydride, tetrahydrophthalic anhydride, methyltetrahydrophthalic anhydride, methylnadic anhydride, hydrogenated methylnadic anhydride, trialkyltetrahydrophthalic anhydride, methylcyclohexene tetracarboxylic dianhydride, benzophenonetetracarboxic dianhydride, aliphatic dibasic polyanhydride, ethylene glycol bisanhydrotrimellitate and glycerin bis(anhydrotrimellitate) monoacetate are used either singly or in combination of two or more.

Furthermore, according to need, the above-mentioned acid anhydrides are mixed at an equivalent ratio relative to the epoxy resin (ratio of the acid anhydride equivalent to the epoxy equivalent) of 0.3 to 2.

If the equivalent ratio is 0.3 or less, a problem occurs in which the epoxy resin is not hardened. An equivalent ratio exceeding 2 causes the bonding strength to be lowered significantly.

It is desirable that the above-mentioned acid hydride be mixed with the epoxy resin within a range of 0.5 to 1.5 in terms of equivalent ratio.

Furthermore, according to need, the hardening temperature of the above-mentioned epoxy resin and acid anhydride is set within a range from room temperature to 150° C., and the hardening time is set within a range from 1 hour to 48 hours. For example, the hardening temperature of the mixture of the epoxy resin and the acid anhydride is set within a range of 100° C.±20° C., and the hardening time of the mixture of the epoxy resin and the acid anhydride is set within a range of 2 hours to 48 hours.

According to the polarizing lens of the invention, due to the use of a mixture of an epoxy resin and an acid anhydride as an adhesive for the polarizing plate, bonding of polyvinyl alcohol constituting the polarizing thin film and the protective film can be ensured. In particular, elusion caused by water of polyvinyl alcohol constituting the polarizing plate can be prevented, enabling waterproofness to be significantly improved.

### BRIEF DESCRIPTION OF THE DRAWINGS

FIG. 1 is a view showing the polarizing lens according to the embodiment of the invention, together with the production process thereof.

### BEST MODE FOR CARRYING OUT THE INVENTION

The polarizing lens according to the embodiment of the invention will be described below in detail with reference to the attached drawing.

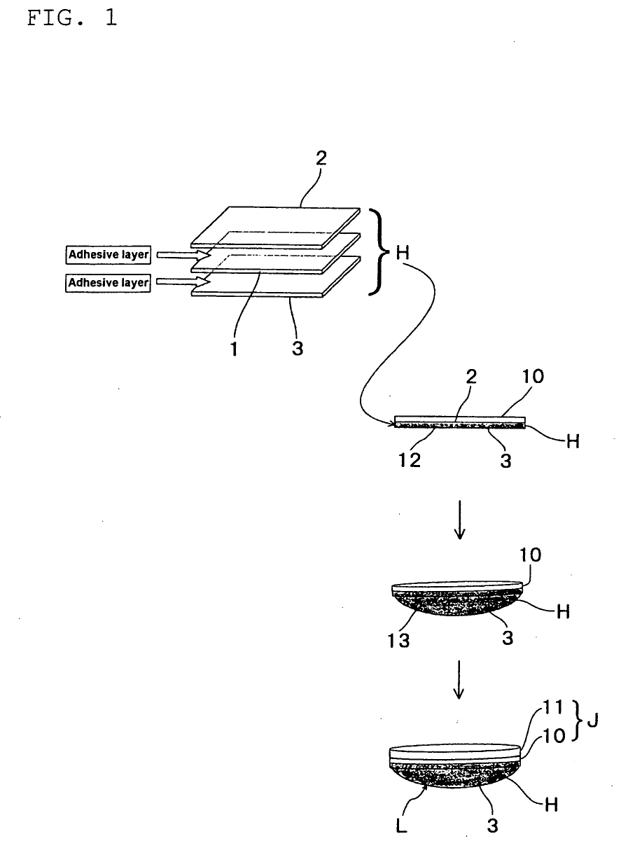

As shown in FIG. 1, in the polarizing lens L according to the embodiment, a polarizing plate H is formed by bonding protective films 2 and 3, which are formed of acetyl cellulose, to both sides of a polarizing thin film 1 formed of polyvinyl alcohol. To one side of this polarizing plate H, a thermoplastic resin film 10 is adhered with an adhesive or a sticking agent to prepare a laminate film 12. The laminate film 12 is then subjected to curved molding such that the thermoplastic resin film 10 is positioned on the concave surface. Thereafter, by injection molding (insert molding), a thermoplastic resin molded layer 11, which is formed of the same resin as the thermoplastic resin film 10, is laminated on the concave surface. As a result, on the concave curved surface of the polarizing plate H, a resin layer J formed of a thermoplastic resin, specifically formed of the thermoplastic resin film 10 and the thermoplastic resin molded layer 11 is laminated.

In the polarizing plate H, the polarizing thin film 1 is an elongated resin sheet of polyvinyl alcohol having a thickness of 0.1 mm or less. It is preferred that the polarizing plate H have a polarization degree of 80% or more, preferably 95% or more. The polarizing thin film 1 can be formed by the iodine doping method or the dye doping method.

The protective films 2 and 3 are formed of acetyl cellulose, and are formed to have a thickness of 0.01 to 1.5 mm, preferably 0.02 to 1.2 mm. The acetyl cellulose can be selected from triacetyl cellulose, diacetyl cellulose, tripropyl cellulose, dipropyl cellulose, or the like.

These protective films 2 and 3 are bonded to both surfaces of the polarizing thin film 1 with an adhesive. The adhesive is applied in a thickness of 0.1 to 100 μm, preferably 0.5 to 80 μm. As the adhesive, a mixture of an epoxy resin and an acid anhydride is used.

Specifically, the epoxy resin is an epoxy resin having two or more epoxy groups within a molecule. As such epoxy resin, glycidyl ether-type, glycidyl ester-type and glycidyl amine-type epoxy resins, linear aliphatic epoxides and cyclic aliphatic epoxy resins are used singly or in combination.

Specifically, as the epoxy resins, bisphenol A diglycidyl ether, bisphenol F diglycidyl ether, bisphenol S diglycidyl ether, resol phenol diglycidyl ether, brominated bisphenol A diglycidyl ether, fluorinated bisphenol A diglycidyl ether, phenol novolac glycidyl ether, cresol novolac glycidyl ether, brominated novolac glycidyl ether, polyglycol diglycidyl ether, hexahydrophthalic diglycidyl ester, phthalic diglycidyl ester, dimer acid diglycidyl ester, diglycidylaniline, diglycidyltoluidine, triglycidyl-p-aminophenol, triglycidyl-p-aminocresol, triglycidyl-m-aminophenol, triglycidyl isocyanulate, tetraglycidyl diaminodiphenyl methane, tetraglycidyl methaxylene diamine, tetraglycidyl diaminodiphenyl sulfoxide, epoxylated polybutadiene, epoxylated soy bean oil, 3,4-epoxy-6-methylcyclohexylmethyl carboxylate, 3,4-epoxycyclohexylmethyl carboxylate, 3,4-epoxycyclohexylmethyl-3′,4′-epoxycylohexane carboxylate, bis(3,4-epoxycylohexylmethyl)adipate and 1-epoxyethyl-3,4-epoxycylohexane are used singly or in combination of two or more.

Furthermore, as the acid anhydride, maleic anhydride, dodecenyl succinic anhydride, sebacic anhydride, phthalic anhydride, pyromellitic anhydride, trimellitic anhydride, cyclopentane tetracarboxylic dianhydride, hexahydrophthalic anhydride, methylhexahyrophthalic anhydride, tetramethylene maleic dianhydride, tetrahydrophthalic anhydride, methyltetrahydrophthalic anhydride, methylnadic anhydride, hydrogenated methylnadic anhydride, trialkyltetrahydrophthalic anhydride, methylcyclohexene tetracarboxylic dianhydride, benzophenonetetracarboxylic dianhydride, aliphatic dibasic polyanhydride, ethylene glycol bisanhydrotrimellitate and glycerin bis(anhydrotrimellitate) monoacetate are used either singly or in combination of two or more.

The above-mentioned acid anhydrides are mixed with the epoxy resin at an equivalent ratio (ratio of the acid anhydride equivalent to the epoxy equivalent) of 0.3 to 2. It is desirable that the above-mentioned acid anhydride be mixed with the epoxy resin within a range of 0.5 to 1.5 in terms of equivalent ratio.

Furthermore, the hardening temperature of the above-mentioned epoxy resin and the acid anhydride is set within a range from room temperature to 150° C., and the hardening time is set within a range from 1 hour to 48 hours. For example, the hardening temperature of the mixture of the epoxy resin and the acid anhydride is set within a range of 100° C.±20° C., and the hardening time of the mixture of the epoxy resin and the acid anhydride is set within a range of 2 hours to 48 hours.

In the resin layer J, an explanation will be made on the thermoplastic film 10 which is bonded to one side of the polarizing plate H and the thermoplastic resin molded layer 11 which are laminated by injection molding. The thermoplastic resin film 10 is, for example, formed of a polycarbonate resin, and is adhered to the protective film 2 of the polarizing plate H in advance with an adhesive or a sticking agent. The thermoplastic resin film 10 is set to have a thickness of 0.01 to 2.0 mm, preferably 0.03 to 1.5 mm. As the adhesive, isocyanate-based, polyurethane-based, polythiourethane-based adhesives or the like are used. As the sticking agent, vinyl acetate-based, acrylic-based sticking agents or the like are used. The laminate film 12 in which the thermoplastic resin film 10 is bonded to the polarizing plate H is then subjected to curved molding by thermal pressing or the like such that the thermoplastic resin film 10 side of the polarizing plate H is positioned on the concave curved surface, followed by blanking to allow the resulting molded product to have a predetermined shape, whereby an intermediate product 13 is produced. Then, on the thermoplastic resin film 10 of the intermediate product 13 in a predetermined shape, which is obtained by curved molding, a thermoplastic resin molded layer 11 is provided by injection molding.

The thermoplastic resin molded layer 11 is formed of a polycarbonate resin, for example. As the polycarbonate resin, a polycarbonate resin with a polymerization degree of 120 or less, preferably 100 or less is used. The polycarbonate resin is then thermally fused, pressed in a die and molded by injection molding, for example. The thermoplastic resin molded layer 11 is molded to have a thickness of 0.5 mm to 20 mm, for example. Then, the thermoplastic resin molded layer 11 is subjected to finishing, whereby a polarizing lens L is obtained as a product.

In the thus formed polarizing lens L product, since a mixture of an epoxy resin and an acid anhydride is used as an adhesive in the polarizing plate H, bonding of polyvinyl alcohol constituting the polarizing thin film 1 and acetyl cellulose constituting the protective films 2 and 3 can be ensured. In particular, elusion caused by water of polyvinyl alcohol constituting the polarizing thin film 1 is prevented, whereby waterproofness is improved. The reason therefor is considered to be as follows. The acid anhydride allows the epoxy resin to be hardened, forms a chemical bonding with the hydroxyl group of polyvinyl alcohol, and undergoes three-dimensional hardening.

### EXAMPLES

Next, the polarizing plate H of the polarizing lens L according to the Examples of the invention is shown. In the polarizing plate H according to the Examples, as the polarizing thin film 1, an elongated resin sheet made of polyvinyl alcohol with a thickness of 0.04 mm (“Kuraray Vinylon #4000”, manufactured by Kuraray Co., Ltd.). As the protective films 2 and 3, triacetyl cellulose with a thickness of 0.08 mm (“Fujitack TA80, manufactured by Fuji Photo Film, Co., Ltd.) was used. Then, these protective films 2 and 3 are adhered to both sides of the polarizing thin film 1 with an adhesive. As the adhesive, a mixture of an epoxy resin and an acid anhydride was used.

### Example 1

In the adhesive, triglycidyl-p-aminophenol (“Epicoat 630” manufactured by Japan Epoxy Resins Co., Ltd.) was used as the epoxy resin. As the acid anhydride, maleic anhydride (Wako Pure Chemical Industries, Ltd.) was used. The maleic anhydride was used in an amount of 105 parts by weight relative to 100 parts by weight of the epoxy resin (1.05 in terms of equivalent ratio (ratio of the acid anhydride equivalent to the epoxy equivalent)).

Then, using this adhesive, at a hardening temperature of 100° C. and a hardening time of 24 hours, the protective films 2 and 3 were adhered to the both sides of the polarizing thin film 1.

### Example 2

In the adhesive, polyglycol diglycidyl ether (“YED205” manufactured by Japan Epoxy Resins Co., Ltd.) was used as the epoxy resin. As the acid anhydride, maleicanhydride (Wako Pure Chemical Industries, Ltd.) was used. The maleic anhydride was used in an amount of 35 parts by weight relative to 100 parts by weight of the epoxy resin (0.5 in terms of equivalent ratio (ratio of the acid anhydride equivalent to the epoxy equivalent)).

Then, using this adhesive, at a hardening temperature of 100° C. and for a hardening time of 24 hours, the protective films 2 and 3 were adhered to the both sides of the polarizing thin film 1.

The polarizing plates H according to these Examples and Comparative Examples were subjected to a water-proof test. In Comparative Examples, as the polarizing thin film 1 and the protective films 2 and 3, the same polarizing thin film 1 and the protective films 2 and 3 as those in the above-mentioned Examples were used, and the composition and the hardening condition of the adhesive were changed.

As the adhesive, the following 9 kinds were used. 6 kinds of an adhesive which each was obtained by a method in which, as the epoxy resin, triglycidyl-p-aminophenol (“Epicoat 630” manufactured by Japan Epoxy Resins Co., Ltd., hereinafter simply referred to as “630”) and a bisphenol A-type epoxy resin (“Epicoat 801” manufactured by Japan Epoxy Resins Co., Ltd., hereinafter simply referred to as “801”) were used as a base, and these epoxy resins were respectively mixed with, as a hardening agent, a denatured alicyclic polyamine compound (bis(2-methyl-4-aminocyclohexyl)methane) (“Epicure 113” manufactured by Japan Epoxy Resins Co., Ltd., hereinafter simply referred to as “113”), polyglycol glycidyl ether (“YED205” manufactured by Japan Epoxy Resins Co., Ltd., hereinafter simply referred to as “YED 205”) and Sodium Ethoxide at a ratio of 100:32 (Comparative Examples 1 to 6); one kind of an adhesive which was obtained by mixing only “630” and “113” at a ratio of 100:64 (Comparative Example 7), one kind of an ethanol solution obtained by mixing 10 wt % of the “maleic anhydride” with “ethanol” (Comparative Example 8), and one kind of an adhesive using only “630”, without using the hardening agent (Comparative Example 9).

As the hardening conditions, the former 6 kinds of the adhesive (Comparative Examples 1 to 6) were hardened at 60° C. and for 72 hours, and all of the latter adhesives (Comparative Examples 7 to 9) were hardened at 100° C. for 24 hours.

The water proof test was performed in the following manner. As a specimen, a film which was formed by bonding and hardening under the above-mentioned conditions was cut into a rectangular strip having a width of 30 mm and a length of 90 mm. This specimen was immersed in hot water of 60° C. for 24 hours to observe it's peeling state.

The results are shown in the following table. As for adhesiveness, the film which could not be peeled off easily by hand was evaluated as “◯”, the film which could be peeled off or could not be adhered easily was evaluated as “X”. As for waterproofness, the film which did not undergo peeling and maintained the excellent state was evaluated as “⊚”, the film which did not undergo peeling and maintained the good state was evaluated as “◯”, and the film of which the outer periphery underwent a slight degree of peeling was evaluated as “Δ”, the film which apparently underwent peeling was evaluated as “X”, and the film which could not be subjected to the test was evaluated as “-”.

The results showed that maleic anhydride was effective in bonding using an epoxy resin.

TABLE

| | Composition of specimen | | | |
|---|---|---|---|---|
| | Base A | Base B | Adhesiveness | Waterproofness |
| Example 1 | 630 | Maleic | ◯ | ⊚ |
| | | anhydride | | |
| Example 2 | YED205 | Maleic | ◯ | ◯ |
| | | anhydride | | |
| Comparative | 630 | 113 | ◯ | X |
| Example 1 | | | | |
| Comparative | 801 | 113 | ◯ | X |
| Example 2 | | | | |
| Comparative | 630 | Sodium | X | — |
| Example 3 | | ethoxide | | |
| Comparative | 801 | Sodium | X | — |
| Example 4 | | ethoxide | | |
| Comparative | 630 | YED205 | X | — |
| Example 5 | | | | |
| Comparative | 801 | YED205 | X | — |
| Example 6 | | | | |
| Comparative | 630 | 113 | ◯ | Δ |
| Example 7 | | | | |
| Comparative | Maleic | Ethanol | X | X |
| Example 8 | anhydride | | | |
| Comparative | 630 | — | X | — |
| Example 9 | | | | |

1. A polarizing lens in which a resin layer formed of a thermoplastic resin is laminated on a polarizing plate obtained by bonding protective films formed of acetyl cellulose to both sides of a polarizing thin film formed of polyvinyl alcohol, wherein the protective films are adhered to both sides of the polarizing thin film with an adhesive, and a mixture of an epoxy resin and an acid anhydride is used as the adhesive.

2. The polarizing lens according to claim 1, wherein the above-mentioned epoxy resin is an epoxy resin having two or more epoxy groups within a molecule, and, as the epoxy resin, glycidylether-based epoxy resins, glycidylester-based epoxy resins, glycidylamine-based epoxy resins, linear aliphatic epoxides, and cyclic aliphatic epoxy resins are used singly or in a combination of two or more.

3. The polarizing lens according to claim 2, wherein, as the epoxy resin, bisphenol A diglycidyl ether, bisphenol F diglycidyl ether, bisphenol S diglycidyl ether, resol phenol diglycidyl ether, brominated bisphenol A diglycidyl ether, fluorinated bisphenol A diglycidyl ether, phenol novolac glycidyl ether, cresol novolac glycidyl ether, brominated novolac glycidyl ether, polyglycol diglycidyl ether, hexahydrophthalic diglycidyl ester, phthalic diglycidyl ester, dimer acid diglycidyl ester, diglycidylaniline, diglycidyltoluidine, triglycidyl-p-aminophenol, triglycidyl-p-aminocresol, triglycidyl-m-aminophenol, triglycidyl isocyanulate, tetraglycidyl diaminodiphenylmethane, tetraglycidylmethaxylenediamine, tetraglycidyl diaminodiphenyl sulfoxide, epoxylated polybutadiene, epoxylated soy bean oil, 3,4-epoxy-6-methylcyclohexylmethyl carboxylate, 3,4-epoxycyclohexylmethyl carboxylate, 3,4-epoxycyclohexylmethyl-3′,4′-epoxycylohexane carboxylate, bis(3,4-epoxycylohexylmethyl)adipate and 1-epoxyethyl-3,4-epoxycylohexane are used singly or in combination of two or more.

4. The polarizing lens according to claim 1, wherein, as the acid anhydrides, maleic anhydride, dodecenyl succinic anhydride, sebacic anhydride, phthalic anhydride, pyromellitic anhydride, trimellitic anhydride, cyclopentane tetracarboxylic dianhydride, hexahydrophthalic anhydride, methylhexahyrophthalic anhydride, maleic tetramethylene anhydride, tetrahydrophthalic anhydride, methyltetrahydrophthalic anhydride, methylnadic anhydride, hydrogenated methylnadic anhydride, trialkyltetrahydrophthalic anhydride, methylcyclohexene tetracarboxylic dianhydride, benzophenonetetracarboxic dianhydride, aliphatic dibasic polyanhydride, ethylene glycol bisanhydrotrimellitate and glycerin bis(anhydrotrimellitate) monoacetate are used either singly or in combination of two or more.

5. The polarizing lens according to claim 2, wherein, as the acid anhydride, maleic anhydride, dodecenyl succinic anhydride, sebacic anhydride, phthalic anhydride, pyromellitic anhydride, trimellitic anhydride, cyclopentane tetracarboxylic dianhydride, hexahydrophthalic anhydride, methylhexahyrophthalic anhydride, maleic tetramethylene anhydride, tetrahydrophthalic anhydride, methyltetrahydrophthalic anhydride, methylnadic anhydride, hydrogenated methylnadic anhydride, trialkyltetrahydrophthalic anhydride, methylcyclohexene tetracarboxylic dianhydride, benzophenonetetracarboxic dianhydride, aliphatic dibasic polyanhydride, ethylene glycol bisanhydrotrimellitate and glycerin bis(anhydrotrimellitate) monoacetate are used either singly or in combination of two or more.

6. The polarizing lens according to claim 3, wherein, as the acid anhydride, maleic anhydride, dodecenyl succinic anhydride, sebacic anhydride, phthalic anhydride, pyromellitic anhydride, trimellitic anhydride, cyclopentane tetracarboxylic dianhydride, hexahydrophthalic anhydride, methylhexahyrophthalic anhydride, maleic tetramethylene anhydride, tetrahydrophthalic anhydride, methyltetrahydrophthalic anhydride, methylnadic anhydride, hydrogenated methylnadic anhydride, trialkyltetrahydrophthalic anhydride, methylcyclohexene tetracarboxlic anhydride, methylcyclohexene tetracarboxylic dianhydride, benzophenonetetracarboxic dianhydride, aliphatic dibasic polyanhydride, ethylene glycol bisanhydrotrimellitate and glycerin bis(anhydrotrimellitate) monoacetate are used either singly or in combination of two or more.

7. The polarizing lens according to claim 4, wherein the acid anhydride is mixed with the epoxy resin at an equivalent ratio (ratio of the acid anhydride equivalent to the epoxy equivalent) of 0.3 to 2.

8. The polarizing lens according to claim 5, wherein the acid anhydride is mixed with the epoxy resin at an equivalent ratio (ratio of the acid anhydride equivalent to the epoxy equivalent) of 0.3 to 2.

9. The polarizing lens according to claim 6, wherein the acid anhydride is mixed with the epoxy resin at an equivalent ratio (ratio of the acid anhydride equivalent to the epoxy equivalent) of 0.3 to 2.

10. The polarizing lens according to claim 7, wherein a mixture of the epoxy resin and the acid anhydride is hardened at a temperature of from room temperature to 150° C. for one hour to 48 hours.

11. The polarizing lens according to claim 8, wherein a mixture of the epoxy resin and the acid anhydride is hardened at a temperature of from room temperature to 150° C. for one hour to 48 hours.

12. The polarizing lens according to claim 9, wherein a mixture of the epoxy resin and the acid anhydride is hardened at a temperature of from room temperature to 150° C. for one hour to 48 hours.
